(19) United States
(12) Patent Application Publication
(10) Pub. No.: US 2026/0252578 A1
(43) Pub. Date: Aug. 27, 2026

(54) ENHANCED SEARCH AND RETRIEVAL USING NEURAL BIOMETRIC METADATA

(71) Applicant: INTERNATIONAL BUSINESS MACHINES CORPORATION, Armonk, NY (US)

(72) Inventors: Sara E. Berger, Beaverton, OR (US); Marc P. Yvon, Antony (FR); Neil Delima, Scarborough (CA)

(21) Appl. No.: 19/065,460

(22) Filed: Feb. 27, 2025

(51) Int. Cl. G06F 16/25; G06F 16/953

(52) U.S. Cl. CPC G06F 16/252; G06F 16/953

(57) ABSTRACT

A biometric data storage and retrieval system includes an aggregator executing within a computer hardware system. Internal metadata of the user captured by a neural computing interface connected to a user is received. External metadata associated with an action performed by the user and captured by the computer device is received. The aggregator aggregates the internal metadata and the external metadata into an aggregation of metadata, and the aggregator stores, within an aggregated metadata store, the aggregation of metadata. The internal metadata is neural biometric metadata associated with a particular action of the user.

### BACKGROUND

The present invention relates to searching and retrieval of computer-stored data, and more specifically, using an aggregation of neural biometric metadata and conventionally-collected external metadata during the search and retrieval of computer-stored data.

Technology exists that allows brain activity to be decoded into visual imagery, text, etc. Functional magnetic resonance imaging (fMRI) and functional near-infrared spectroscopy (fNIRS) are two neuroimaging techniques used to measure hemodynamic changes associated with neural activity. Functional MRI measures the blood oxygen level-dependent (BOLD) response that results from local concentration changes in paramagnetic deoxy-hemoglobin (deoxy-Hb), while fNIRS measures the concentration changes of both oxygenated and deoxygenated hemoglobin (oxy- and deoxy-Hb). Employing these approaches (either singularly or combined) along with computational models can permit a person's dynamic visual experiences to be decoded and reconstructed. Consequently, one's neural biometric information (thoughts) are capable of being decoded into imagery and/or text. However, there is no currently-known approach to employ this neural biometric information in the search/storage/retrieval of concurrent external information.

### SUMMARY

A method is performed by a biometric data storage and retrieval system including an aggregator executing within a computer hardware system. Internal metadata of the user captured by a neural computing interface connected to a user is received. External metadata associated with an action performed by the user and captured by the computer device is received. The aggregator aggregates the internal metadata and the external metadata into an aggregation of metadata, and the aggregator stores, within an aggregated metadata store, the aggregation of metadata. The internal metadata is neural biometric metadata associated with a particular action of the user.

Additionally, the methodology includes receiving an indication from the user to opt into capturing of the internal metadata by the neural computing interface. The aggregator can include an artificial intelligence (AI) agent configured to identify associations between a particular slice of the internal metadata and a particular slice of the external metadata. Additionally, the particular slice of the internal metadata and the particular slice of the external metadata are associated with a same time.

In certain aspects, a search query is received from the user and by a search engine. Search results are retrieved using the aggregated metadata store and the search query, and the search results are forwarded to the user. A determination can be made that the search results include an internal metadata component, and a term referencing external metadata and associated with the internal metadata component can be identified within the search query. If so, the internal metadata component is retrieved by the search engine using aggregated metadata that associates the term referencing external metadata with the internal metadata component. Alternatively, a determination can be made that the search results include an external metadata component, and a term referencing internal metadata and associated with the external metadata component is identified within the search query. If so, the external metadata component is retrieved by the search engine using aggregated metadata that associates the term referencing internal metadata with the external metadata component. A determination can also be made that the search results include an internal metadata component and an external metadata component.

A biometric data storage and retrieval system includes an aggregator executing within a computer hardware system. The computer hardware system also includes a hardware processor configured to initiate the following operations. Internal metadata of the user captured by a neural computing interface connected to a user is received. External metadata associated with an action performed by the user and captured by the computer device is received. The aggregator aggregates the internal metadata and the external metadata into an aggregation of metadata, and the aggregator stores, within an aggregated metadata store, the aggregation of metadata. The internal metadata is neural biometric metadata associated with a particular action of the user.

Additionally, the system includes receiving an indication from the user to opt into capturing of the internal metadata by the neural computing interface. The aggregator can include an artificial intelligence (AI) agent configured to identify associations between a particular slice of the internal metadata and a particular slice of the external metadata. Additionally, the particular slice of the internal metadata and the particular slice of the external metadata are associated with a same time.

In certain aspects, a search query is received from the user and by a search engine. Search results are retrieved using the aggregated metadata store and the search query, and the search results are forwarded to the user. A determination can be made that the search results include an internal metadata component, and a term referencing external metadata and associated with the internal metadata component can be identified within the search query. If so, the internal metadata component is retrieved by the search engine using aggregated metadata that associates the term referencing external metadata with the internal metadata component. Alternatively, a determination can be made that the search results include an external metadata component, and a term referencing internal metadata and associated with the external metadata component is identified within the search query. If so, the external metadata component is retrieved by the search engine using aggregated metadata that associates the term referencing internal metadata with the external metadata component. A determination can also be made that the search results include an internal metadata component and an external metadata component.

A computer program product comprises a computer readable storage medium having stored therein program code. The program code, which when executed by a biometric data storage and retrieval system includes an aggregator executing within a computer hardware system, causes the computer hardware system to perform the following. Internal metadata of the user captured by a neural computing interface connected to a user is received. External metadata associated with an action performed by the user and captured by the computer device is received. The aggregator aggregates the internal metadata and the external metadata into an aggregation of metadata, and the aggregator stores, within an aggregated metadata store, the aggregation of metadata. The internal metadata is neural biometric metadata associated with a particular action of the user.

Additionally, the compute program product includes receiving an indication from the user to opt into capturing of the internal metadata by the neural computing interface. The aggregator can include an artificial intelligence (AI) agent configured to identify associations between a particular slice of the internal metadata and a particular slice of the external metadata. Additionally, the particular slice of the internal metadata and the particular slice of the external metadata are associated with a same time.

In certain aspects, a search query is received from the user and by a search engine. Search results are retrieved using the aggregated metadata store and the search query, and the search results are forwarded to the user. A determination can be made that the search results include an internal metadata component, and a term referencing external metadata and associated with the internal metadata component can be identified within the search query. If so, the internal metadata component is retrieved by the search engine using aggregated metadata that associates the term referencing external metadata with the internal metadata component. Alternatively, a determination can be made that the search results include an external metadata component, and a term referencing internal metadata and associated with the external metadata component is identified within the search query. If so, the external metadata component is retrieved by the search engine using aggregated metadata that associates the term referencing internal metadata with the external metadata component. A determination can also be made that the search results include an internal metadata component and an external metadata component.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 is a block diagram illustrating an example architecture of a neural biometric data retrieval and storage system according to an embodiment of the present invention.

FIG. 2 is a block diagram illustrating a methodology of generating an aggregation of metadata from a neural computing interface using the architecture of FIG. 1 according to an embodiment of the present invention.

FIG. 3 is a block diagram illustrating a methodology of for retrieving previously-stored aggregated metadata using the architecture of FIG. 1 according to an embodiment of the present invention.

FIG. 4 is a block diagram illustrating an example of a computer environment for implementing portions of the methodology of FIGS. 2 and 3.

### DETAILED DESCRIPTION

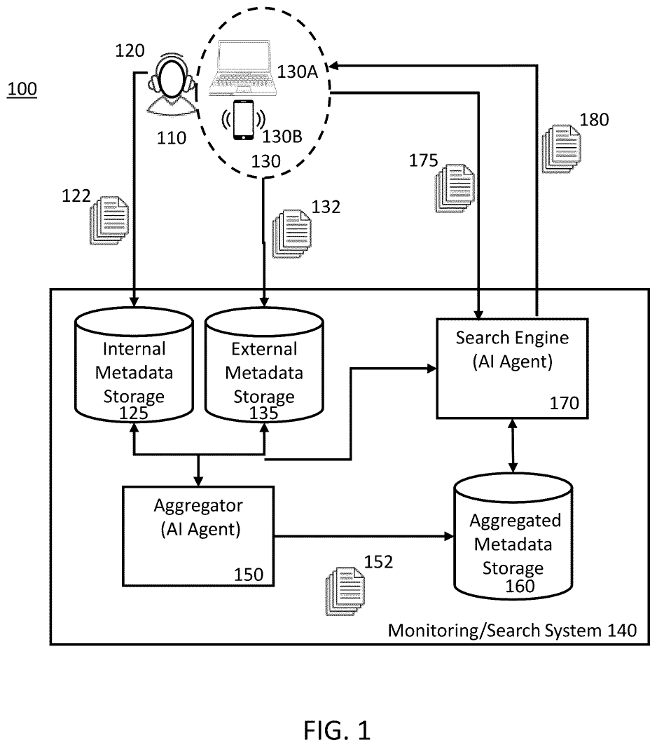

Referring to FIGS. 1-3, an exemplary neural biometric data storage and retrieval system 100 and methodologies 200, 300 of using the same are illustrated. In general, the methodology 200, 300 includes internal metadata 122 of a user 110 being captured by a neural computing interface 120 connected to the user 110. External metadata 132 associated with an action performed by the user 110 and captured by a computer device 130 is received. An aggregator 150 aggregates the internal metadata 122 and the external metadata 132 into an aggregation of metadata 152, and the aggregator 150 stores, within an aggregated metadata store 160, the aggregation of metadata 152. The internal metadata 122 is neural biometric metadata associated with a particular action of the user 110. In certain aspects, a search query 175 is received from the user 110 and by a search engine 170. Search results 180 are retrieved using the aggregated metadata store 160 and the search query, 175 and the search results 180 are forwarded to the user 110.

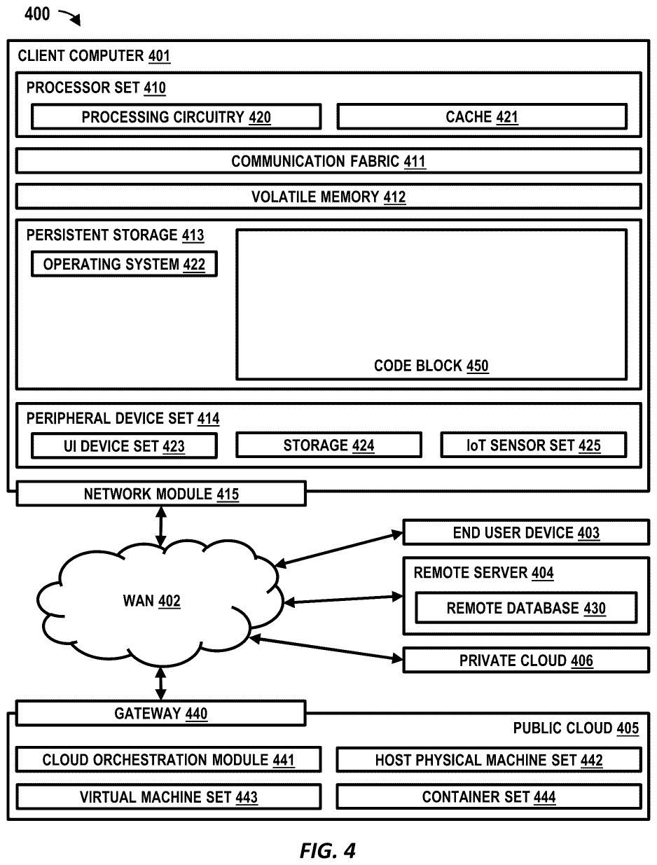

Although not limited in this manner, the neural biometric data storage and retrieval system 100 includes a monitoring/search engine 140 having a number of components including an aggregator 150 and a search engine 170. Although these components are illustrated as being separate components, one or more of these components can be integrated together and/or provided as software as a service, as further described with regard to FIG. 4. The aggregator 150 and search engine 170 can also include trained artificial intelligence (AI) agents. Additionally, one or more aspects of the aggregator 150 and search engine 170 can be split (as illustrated in FIG. 1) or combined.

The internal metadata storage 125, external metadata storage 135, and aggregated metadata store 160 can be external to the monitoring/search system 140 and/or or in a distributed database system. Additionally, the individual storage 125, 135, 160 can be separated (as illustrated) or one or more portions can be merged together within a single database system.

The neural computing interface 120 is configured to contemporaneous retrieve internal metadata 122 from a user 110. As used herein, “internal metadata” is defined as being neural biometric metadata (e.g., imagery, words/text, feelings) associated with a particular event/action. The internal metadata 122 can also include an object on which the event/action occurs as well as a timestamp and a location. The neural biometric data storage and retrieval system 100 is not limited as to a particular neural computing interface 120 used to generate internal metadata 122. As previously discussed, examples of devices capable of performing the function of the neural computing interface include fMRI and fNIRS. Other techniques that can also be used include electroencephalography (EEG) and magnetoencephalography (MEG). A neural computing interface 120 can also be a brain-computer interface (BCI) or human-machine interface (HMI), which are known technologies.

As an example, “time cells” keep track of the when in an episodic memory. Another group of cells called “place cells” keep track of exactly where a user 105 was/is when the episode occurred (e.g., the direction facing in a given space, like a room). A third group of cells called “grid cells” also keep track of where a user 105 is in a given context, but this position can encode a much larger space of across X, Y, and Z axes (e.g., the user 105 is in a room of a house in a neighborhood in a town in a county in a state, etc.) and is less specific in terms of direction or visual surroundings. Time cells, place cells, and grid cells are all neurons in the hippocampus and/or entorhinal cortex (i.e., areas of the brain involved with memory, navigation, and emotion) that fire at specific moments within a cognitive task, experience, or location. The neural computing interface 120 is configured to monitor, for example, these different types of cells and to gather the internal metadata 122 therefrom.

The neural computing interface 120 can provide the internal metadata 122 directly to the monitoring/search system 140 or use an intermediary device, such as the computing device 130. Additionally, the neural computing interface 120 can provide raw internal metadata 122 to the monitoring/search system 140 and/or the neural computing interface and/or the computer device 130 can provide preprocessing of the internal metadata 122. For example, the preprocessing can include, for example, providing a timestamp to the internal metadata 122, performing signal processing on the internal metadata 122, and translating the raw internal metadata 122 to identify an action/event, object upon which the action/event occurs, a place, and/or a time associated with the action/event.

The one or more computing devices 130 for capturing external metadata 132 are not limited. The one or more computing devices can be exclusively associated with the user 110 (e.g., a personal mobile device 130 or a personal laptop 130A) or local devices such as Internet of Things (IoT) devices, wearables, smart devices, sensors, video cameras, etc. As used herein, “external metadata” is defined as contextual data regarding actions/activities performed in the external world (i.e., outside a human being) during which the internal metadata 122 is captured. The external metadata 132 can describe the environment of the user 110, such as temperature, physical location, nearby devices/persons and/or actions being performed by the user (e.g., using the computing device 130), such as watching a video, reading an article, streaming a song, and interacting with an application. Additionally, the external metadata 132 can be associated with a particular time or time frame, for example, using a timestamp.

The aggregator 150 is configured to aggregate the internal metadata 122 and the external metadata 132 to generate an aggregation of metadata 152. In particular, the aggregation of metadata 152 are the identified associations between the internal metadata 122 and external metadata 132 that relate to a same time or time frame (i.e., a particular period of time). Although not limited in this manner, the aggregator 150 can employ a pretrained AI agent configured to identify associations between a particular slice (i.e., partial portion) of the internal metadata 122 and a particular slice of the external metadata 132. In certain aspects, the particular slice of the internal metadata 122 and the particular slice of the external metadata 132 are associated with the same time (i.e., a particular time or time period).

The search engine 170 is configured to receive search queries 175 and return search results 180. In particular, the search engine 170 leverage the associations found within the aggregated metadata store 160 to retrieve the associations and/or previously-stored internal metadata 122 from the internal metadata storage 125 and/or previously-stored external metadata 132 from the external metadata storage 135. Like the aggregator 150, the search engine 170 can also employ a trained AI agent that is configured to identify associations between the internal metadata 122 and the external metadata 132. The AI agent can also be trained to learn the associations from previously-encountered experiences, experienced mental representation induced by activities, and to suggest to the user some associations. For instance, reading about safety equipment to bring in a mountain hike could cause the AI agent to complement the search results 180 with additional “things to think about” while preparing this activity.

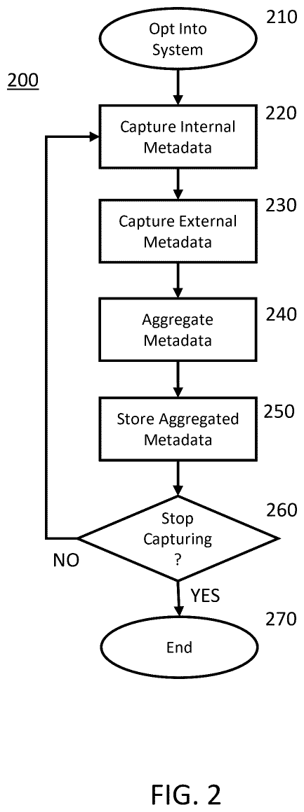

With specific reference to FIG. 2, an overview of the general process 200 for generating an aggregation of metadata 152 from a neural computing interface 120 is disclosed. In 210, the user 110 initiates the process 200 by choosing to opt into use of the biometric data storage and retrieval system 100.

In 220, the neural computing interface 120 is configured to capture internal metadata 122 associated with the user 110 and forward that internal metadata 122 to the monitoring/search system 140. Although not limited in this manner, the internal metadata 122 can include neural biometric data such images, words, feelings. The internal metadata 122 can also include information associated with time cells, place cells, and grid cells.

Upon the neural computing interface 120 capturing the internal metadata 122, the internal metadata 122 is forwarded to the monitoring/search system 140 for storage in a database for internal metadata 125. Although illustrated in FIG. 1 as being forwarded directly to the monitoring/search system 140 from the neural computing interface 120, the process 200 is not limited in this manner. For example, the neural computing interface 120 can interface with one of the computer devices 130, which can then forward the internal metadata 122 to the monitoring/search system 140.

In 230, the monitoring/search system 140 is configured to receive external metadata 132 from one or more computer devices 130 associated with the user 110. Although not limited in this manner, the external metadata 132 is contextual information associated with the user 110 and can include information such as time, place, application being used, content being browsed, an event, an ongoing activity, etc. Whereas internal metadata 122 is biometric data associated with the user 110, the external metadata 132 is data associated with events/activities/context external to the user 110.

Upon the one or more computer devices 130 capturing the external metadata 132, the external metadata 132 is forwarded to the monitoring/search system 140 for storage in an external metadata store 125. The manner in which the external metadata 132 is forwarded to the monitoring/search system 140 from the one or more computer devices 130 is not limited to a particular methodology or technology.

Additionally, either or both of the neural computing interface 120 and the one or more computing devices can perform preprocessing on the internal/external metadata 122, 132 prior to this data being sent to the monitoring/search system 140.

In 240, the aggregator 150 aggregates the internal metadata 122 with the external metadata 132. In particular, the aggregator 150 identifies associations between internal metadata 122 and external metadata 132 that relate to a same (or similar) time and/or events. These associations can be stored as an aggregation of metadata 152. Additionally, the internal metadata 122 and the external metadata 132 can be combined and stored as the aggregation of metadata 152. Alternatively, the aggregation of metadata 152 can includes pointers to the database for internal metadata 125 and the database for external metadata 135. In so doing, the external metadata 132 serve to provide contextual information to the internal metadata 122. Additionally, the aggregator 150 can include an AI agent that can be trained using past associations between internal metadata 122 and external metadata 132 to predict future associations. In 250, the aggregator 150 stores this aggregation of metadata 152 in a storage of aggregated metadata store 160.

In 260, a determination is made whether to continue capturing internal metadata 122 and external metadata 132. For example, the user 105 may opt out of capturing internal metadata 122 and external metadata 132. If so, the process 200 ends in 270. Otherwise, the process 200 repeats itself by returning to the capturing of internal metadata 220 and the capturing of external metadata 230. Although illustrated as being performed in series, the capturing of internal metadata 122 in 220 and the capturing of external metadata 132 in 230 can be performed in a different order or in parallel.

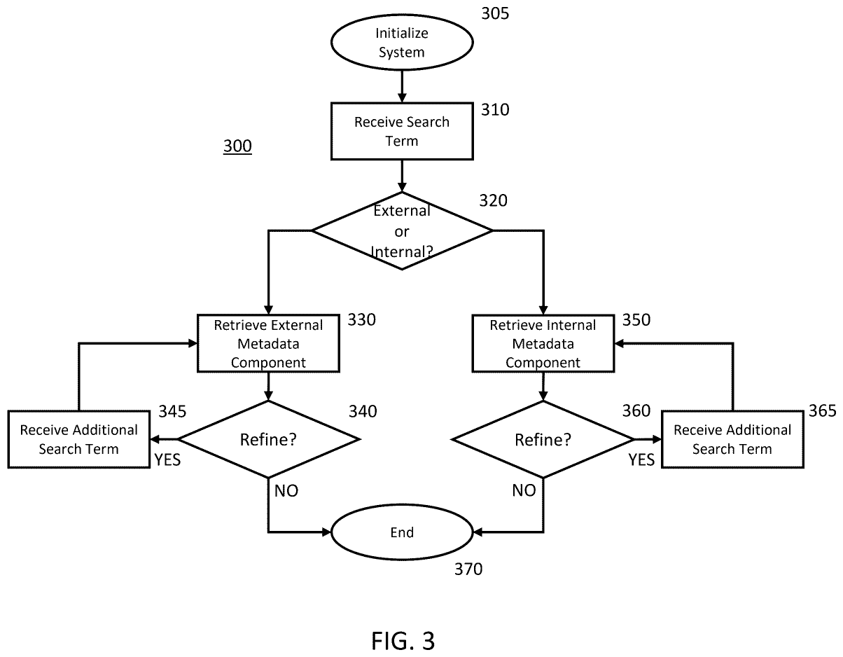

With specific reference to FIG. 3, an overview of the general process 300 for retrieving search results 180 using an aggregated metadata store 160 is disclosed. The general process 300 for retrieving search results 180 using the aggregated metadata store 160 is intended to following the process 200 illustrated in FIG. 2, during which associations between the internal metadata 122 and external metadata 132 are identified and stored within the aggregated metadata store 160.

In 305, the user 110 initiates the process 300 by accessing the monitoring/search system 140 using a computer device 130. In 310, the monitoring/search system 140 receives a search query 175 from a computer device 130 associated with the user 110. Although not limited in this manner, the search query 175 can be in natural language, which can be parsed using a natural language processor within the search engine 170.

In 320, the search engine 170 makes a determination whether the search query 175 is intended to retrieve an internal metadata 122 component, external metadata 132 component or a combination of both 122, 132. For example, the search engine 170 may identify, within the search query 175, a search term referencing (either explicitly or inferentially) external metadata 132 and associated with an internal metadata 122 component to be retrieved. In addition to or alternatively, the search engine 170 may identify, within the search query 175, a search term referencing (either explicitly or inferentially) internal metadata 122 and associated with an external metadata 132 component to be retrieved.

In 330, if the determination is to retrieve an external metadata 132 component, the search engine 170 searches the aggregated metadata store 160 for an aggregation of metadata 152 that includes the search term referencing internal metadata 122 and associated with the external metadata 132 component. The aggregation of metadata 152 can then provide the search engine 170 directly (or indirectly via a pointer to the external metadata storage 135) the external metadata 132 component being searched for. The external metadata 132 component can then be provided as part of search results 180 to the user 110.

In 340, the user 110 can make a determination to refine the results. If so, in 345, the user 110 can provide an additional search term that can be used by the search engine 170. If not, the process 300 ends at 370.

Alternatively, in 350, if the determination is to retrieve an internal metadata 122 component, the search engine 170 searches the aggregated metadata store 160 for an aggregation of metadata 152 that includes the search term referencing external metadata 132 and associated with the internal metadata 122 component. The aggregation of metadata 152 can then provide the search engine 170 directly (or indirectly via a pointer to the internal metadata storage 125) the internal metadata 122 component being searched for. The internal metadata 122 component can then be provided as part of search results 180 to the user 110.

In 360, the user 110 can make a determination to refine the results. If so, in 365, the user 110 can provide an additional search term that can be used by the search engine 170. If not, the process 300 ends at 370.

Although shown as distinctive operations, the retrieving of the external metadata 132 in 330 and the retrieving of the internal metadata 122 in 350 can occur simultaneously, for example, if the search query is intended to retrieve both an internal metadata 122 component and an external metadata 132 component.

As an example use case, a user (John) wears a neural computing interface 120 and choses to opt into use of the neural biometric data storage and retrieval system 100. John is reading a book on a Saturday, and on page 23 of the book, there is a description of a city along a seaside. The system 100 recognizes (as external metadata) that John is reading the book, the book is at page 23, and the particular content of the book at page 23. The neural computing interface 120 detects brain signals (as internal metadata) that indicate time and an image of a boat (as John recalls his childhood with his grandparents who had a boat) and captures and stores this as internal metadata 122. The system 100 then creates an association between the internal metadata 122 and external metadata 132 and that association is stored as an aggregation of metadata 152.

Subsequently, after John has finished reading, John provides a search query 175 that requests real word metadata (i.e., external metadata 132) that corresponds to the image of a boat (i.e., internal metadata 122). The system 100 is then capable of retrieving imagery of a boat based upon the search query 175. John can also subsequently refine the imagery using additional search terms.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

Referring to FIG. 4, computing environment 400 contains an example of an environment for the execution of at least some of the computer code involved in performing the inventive methods, such as code block 450 for implementing the operations of the code change evaluation system 100. Computing environment 400 includes, for example, computer 401, wide area network (WAN) 402, end user device (EUD) 403, remote server 404, public cloud 405, and private cloud 406. In certain aspects, computer 401 includes processor set 410 (including processing circuitry 420 and cache 421), communication fabric 411, volatile memory 412, persistent storage 413 (including operating system 422 and method code block 450), peripheral device set 414 (including user interface (UI), device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

Computer 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. However, to simplify this presentation of computing environment 400, detailed discussion is focused on a single computer, specifically computer 401. Computer 401 may or may not be located in a cloud, even though it is not shown in a cloud in FIG. 4 except to any extent as may be affirmatively indicated.

Processor set 410 includes one, or more, computer processors of any type now known or to be developed in the future. As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In certain computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods discussed above in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in code block 450 in persistent storage 413.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible, hardware device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Communication fabric 411 is the signal conduction paths that allow the various components of computer 401 to communicate with each other. Typically, this communication fabric 411 is made of switches and electrically conductive paths, such as the switches and electrically conductive paths that make up busses, bridges, physical input/output ports and the like. Other types of signal communication paths may be used for the communication fabric 411, such as fiber optic communication paths and/or wireless communication paths.

Volatile memory 412 is any type of volatile memory now known or to be developed in the future. Examples include dynamic type random access memory (RAM) or static type RAM. Typically, the volatile memory 412 is characterized by random access, but this is not required unless affirmatively indicated. In computer 401, the volatile memory 412 is located in a single package and is internal to computer 401. In addition to alternatively, the volatile memory 412 may be distributed over multiple packages and/or located externally with respect to computer 401.

Persistent storage 413 is any form of non-volatile storage for computers that is now known or to be developed in the future. The non-volatility of the persistent storage 413 means that the stored data is maintained regardless of whether power is being supplied to computer 401 and/or directly to persistent storage 413. Persistent storage 413 may be a read only memory (ROM), but typically at least a portion of the persistent storage 413 allows writing of data, deletion of data and re-writing of data. Some familiar forms of persistent storage 413 include magnetic disks and solid state storage devices. Operating system 422 may take several forms, such as various known proprietary operating systems or open source Portable Operating System Interface type operating systems that employ a kernel. The code included in code block 450 typically includes at least some of the computer code involved in performing the inventive methods.

Peripheral device set 414 includes the set of peripheral devices for computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet.

In various aspects, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some aspects, storage 424 may take the form of a quantum computing storage device for storing data in the form of qubits. In aspects where computer 401 is required to have a large amount of storage (for example, where computer 401 locally stores and manages a large database) then this storage 424 may be provided by peripheral storage devices designed for storing very large amounts of data, such as a storage area network (SAN) that is shared by multiple, geographically distributed computers. Internet-of-Things (IoT) sensor set 425 is made up of sensors that can be used in IoT applications. For example, one sensor may be a thermometer and another sensor may be a motion detector.

Network module 415 is the collection of computer software, hardware, and firmware that allows computer 401 to communicate with other computers through a Wide Area Network (WAN) 402. Network module 415 may include hardware, such as modems or Wi-Fi signal transceivers, software for packetizing and/or de-packetizing data for communication network transmission, and/or web browser software for communicating data over the internet. In certain aspects, network control functions and network forwarding functions of network module 415 are performed on the same physical hardware device. In other aspects (for example, aspects that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any Wide Area Network (for example, the internet) capable of communicating computer data over non-local distances by any technology for communicating computer data, now known or to be developed in the future. In some aspects, the WAN 402 ay be replaced and/or supplemented by local area networks (LANs) designed to communicate data between devices located in a local area, such as a Wi-Fi network. The WAN 402 and/or LANs typically include computer hardware such as copper transmission cables, optical transmission fibers, wireless transmission, routers, firewalls, switches, gateway computers and edge servers.

End user device (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In certain aspects, EUD 403 may be a client device, such as thin client, heavy client, mainframe computer, desktop computer and so on.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein. As defined herein, the term “user” means a person (i.e., a human being).

Remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404. As defined herein, the term “server” means a data processing system configured to share services with one or more other data processing systems.

Public cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

VCEs can be stored as “images,” and a new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 406 is similar to public cloud 405, except that the computing resources are only available for use by a single enterprise. While private cloud 406 is depicted as being in communication with WAN 402, in other aspects, a private cloud 406 may be disconnected from the internet entirely (e.g., WAN 402) and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 405 and private cloud 406 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As another example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Each block in the flowchart or block diagrams may represent a module, segment, or portion of instructions, which comprises one or more executable instructions for implementing the specified logical function(s).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “if,” “when,” “upon,” “in response to,” and the like are not to be construed as indicating a particular operation is optional. Rather, use of these terms indicate that a particular operation is conditional. For example and by way of a hypothetical, the language of “performing operation A upon B” does not indicate that operation A is optional. Rather, this language indicates that operation A is conditioned upon B occurring.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

1. A computer-implemented method by a biometric data storage and retrieval system including an aggregator executing within a computer hardware system, the computer-implemented method comprising:
monitoring, via a neural computing interface connected to a user, a plurality of brain cells of the user;
capturing, based on the monitoring, internal metadata of the user, wherein the internal metadata is neural biometric metadata associated with a first action of the user;
capturing, via a computer device and a plurality of sensors, external metadata comprising environment data and contextual data, wherein
the environment data is associated with an environment of the user,
the contextual data is associated with a second action performed by the user, and
the capturing of the external metadata is performed in parallel to the capturing of the internal metadata;
aggregating, by the aggregator, the internal metadata and the external metadata to generate aggregated metadata;
storing, by the aggregator and into an aggregated metadata store, the aggregated metadata;
receiving, by a search engine, a search query from the user;
in a case where a term referencing the external metadata associated with an internal metadata component of the internal metadata is identified from the search query, retrieving, by the search engine from the aggregated metadata store, search results comprising the internal metadata component, wherein the search results are retrieved based on the aggregated metadata and the search query; and
forwarding the search results to a user device associated with the user.

2. The computer-implemented_method of claim 1, further comprising:
receiving an indication from the user to opt into the capturing of the internal metadata by the neural computing interface.

3. The computer-implemented method of claim 1, wherein
the aggregator includes an artificial intelligence (AI) agent configured to identify associations between a particular slice of the internal metadata and a particular slice of the external metadata.

4. The computer-implemented method of claim 3, wherein
the particular slice of the internal metadata and the particular slice of the external metadata are associated with a same time.

5. (canceled)

6. (canceled)

7. The computer-implemented method of claim 1, wherein
in a case where a term referencing the internal metadata associated with an external metadata component of the external metadata is identified within the search query,
retrieving, by the search engine, search results comprising the external metadata component, based on the aggregated metadata and the search query.

8. The computer-implemented method of claim 1, wherein
in a case where a term referencing the internal metadata associated with an external metadata component, and the external metadata associated with the internal metadata component is identified in the search query, retrieving, by the search engine, search results comprising a combination of the internal metadata component and the external metadata component.

9. A biometric data storage and retrieval system including an aggregator executing within a computer hardware system, the system comprising:
a hardware processor configured to initiate operations comprising:
monitoring, via a neural computing interface connected to a user, a plurality of brain cells of the user;
capturing, based on the monitoring, internal metadata of the user, wherein the internal metadata is neural biometric metadata associated with a first action of the user;
capturing, via a computer device and a plurality of sensors, external metadata comprising environment data and contextual data, wherein
the environment data is associated with an environment of the user,
the contextual data is associated with a second action performed by the user, and
the capturing of the external metadata is performed in parallel to the capturing of the internal metadata;
aggregating, by the aggregator, the internal metadata and the external metadata to generate aggregated metadata;
storing, by the aggregator and into an aggregated metadata store, the aggregated metadata;
receiving, by a search engine, a search query from the user;
in a case where a term referencing the external metadata associated with an internal metadata component of the internal metadata is identified from the search query, retrieving, by the search engine from the aggregated metadata store, search results comprising the internal metadata component, wherein the search results are retrieved based on the aggregated metadata and the search query; and
forwarding the search results to a user device associated with the user.

10. The system of claim 9, wherein the hardware processor is further configured to initiate the operations further comprising:
receiving an indication from the user to opt into the capturing of the internal metadata by the neural computing interface.

11. The system of claim 9, wherein
the aggregator includes an artificial intelligence (AI) agent configured to identify associations between a particular slice of the internal metadata and a particular slice of the external metadata.

12. The system of claim 11, wherein
the particular slice of the internal metadata and the particular slice of the external metadata are associated with a same time.

13. (canceled)

14. (canceled)

15. The system of claim 9, wherein
in a case where a term referencing the internal metadata associated with an external metadata component of the external metadata is identified within the search query,
retrieving, by the search engine, search results comprising the external metadata component, based on the aggregated metadata and the search query.

16. The system of claim 9, wherein
in a case where a term referencing the internal metadata associated with an external metadata component, and the external metadata associated with the internal metadata component is identified in the search query, retrieving, by the search engine, search results comprising a combination of the internal metadata component and the external metadata component.

17. A computer program product, comprising:
a computer readable storage medium having stored therein program code,
the program code, which when executed by a biometric data storage and retrieval system including an aggregator executing within a computer hardware system, causes the computer hardware system to perform:
monitoring, via a neural computing interface connected to a user, a plurality of brain cells of the user;
capturing, based on the monitoring, internal metadata of the user, wherein the internal metadata is neural biometric metadata associated with a first action of the user;
capturing, via a computer device and a plurality of sensors, external metadata comprising environment data and contextual data, wherein
the environment data is associated with an environment of the user,
the contextual data is associated with a second action performed by the user device, and
the capturing of the external metadata is performed in parallel to the capturing of the internal metadata;
aggregating, by the aggregator, the internal metadata and the external metadata to generate aggregated metadata;
storing, by the aggregator and into an aggregated metadata store, the aggregated metadata;
receiving, by a search engine, a search query from the user;
in a case where a term referencing the external metadata associated with an internal metadata component of the internal metadata is identified from the search query, retrieving, by the search engine from the aggregated metadata store, search results comprising the internal metadata component, wherein the search results are retrieved based on the aggregated metadata and the search query; and
forwarding the search results to a user device associated with the user.

18. The computer program product of claim 17, wherein
the aggregator includes an artificial intelligence (AI) agent configured to identify associations between a particular slice of the internal metadata and a particular slice of the external metadata.

19. (canceled)

20. (canceled)

21. The computer-implemented method of claim 1, wherein the aggregated metadata includes a first pointer to a first database for the internal metadata and a second pointer to a second database for the external metadata.
